(19) United States
(12) Patent Application Publication
(10) Pub. No.: US 2024/0333518 A1
(43) Pub. Date: Oct. 3, 2024

(54) Audit Chain for Encrypted Hashes

(71) Applicant: MICRO FOCUS LLC, Santa Clara, CA (US)

(72) Inventors: DOUGLAS MAX GROVER, Rigby, ID (US); MICHAEL F. ANGELO, Houston, TX (US)

(73) Assignee: MICRO FOCUS LLC, Santa Clara, CA (US)

(21) Appl. No.: 18/191,747

(22) Filed: Mar. 28, 2023

(51) Int. Cl. H04L 9/32; H04L 9/00

(52) U.S. Cl. CPC H04L 9/3242; H04L 9/50

(57) ABSTRACT

A first hash of a record is retrieved. The first hash is encrypted using an encryption key to produce an encrypted hash. The encrypted hash is stored in the record by replacing the first hash with the encrypted hash or by adding the encrypted hash to the record. A request is received to validate the record. In response to receiving the request to validate the record, the record is validated by: unencrypting the encrypted hash using the encryption key to produce a second hash; hashing the record to produce a third hash; and comparing the second hash to the third hash. In response to the second hash being the same as the third hash, the record is validated. In response to the second hash not being the same as the third hash, the record is not validated.

### FIELD

The disclosure relates generally to auditing software and particularly to auditing software using encrypted hashes.

### BACKGROUND

With the advance of advanced computing (e.g., quantum computing), the ability to find hash collisions (where different data produces the same hash result) leaves the potential for existing hashing techniques to be compromised.

### SUMMARY

These and other needs are addressed by the various embodiments and configurations of the present disclosure. The present disclosure can provide a number of advantages depending on the particular configuration. These and other advantages will be apparent from the disclosure contained herein.

A first hash of a record is retrieved. For example, the first hash may be a hash of a block in a blockchain or a hash of a file. The first hash is encrypted using an encryption key to produce an encrypted hash. The encrypted hash is stored in the record by replacing the first hash with the encrypted hash or by adding the encrypted hash to the record. A request is received to validate the record. In response to receiving the request to validate the record, the record is validated by: unencrypting the encrypted hash using the encryption key to produce a second hash; hashing the record to produce a third hash; and comparing the second hash to the third hash. In response to the second hash being the same as the third hash, the record is validated. In response to the second hash not being the same as the third hash, the record is not validated.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The term “blockchain” as described herein and in the claims refers to a growing list of records, called blocks, which are linked using cryptography. The blockchain is commonly a decentralized, distributed and public digital ledger that is used to record transactions across many computers so that the record cannot be altered retroactively without the alteration of all subsequent blocks and the consensus of the network. Each block contains a cryptographic hash of the previous block, a timestamp, and transaction data (generally represented as a merkle tree root hash). For use as a distributed ledger, a blockchain is typically managed by a peer-to-peer network collectively adhering to a protocol for inter-node communication and validating new blocks. Once recorded, the data in any given block cannot be altered retroactively without alteration of all subsequent blocks, which requires consensus of the network majority. In verifying or validating a block in the blockchain, a hashcash algorithm generally requires the following parameters: a service string, a nonce, and a counter. The service string can be encoded in the block header data structure, and include a version field, the hash of the previous block, the root hash of the merkle tree of all transactions (or information or data) in the block, the current time, and the difficulty level. The nonce can be stored in an extraNonce field, which is stored as the left most leaf node in the merkle tree. The counter parameter is often small at 32-bits so each time it wraps the extraNonce field must be incremented (or otherwise changed) to avoid repeating work. When validating or verifying a block, the hashcash algorithm repeatedly hashes the block header while incrementing the counter & extraNonce fields. Incrementing the extraNonce field entails recomputing the merkle tree, as the transaction or other information is the left most leaf node. The body of the block contains the transactions or other information. These are hashed only indirectly through the Merkle root.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system to provide an audit chain using encrypted hashes.

FIG. 2 is a block diagram of a second illustrative system to provide an audit chain using encrypted hashes.

FIG. 3 is a flow diagram of a process for generating and storing encrypted hashes in a record.

FIG. 4 is a flow diagram of a process for unencrypting encrypted hashes to verify that a record has not been tampered with.

FIG. 5 is a block diagram of a blockchain with hashes.

FIG. 6 is a block diagram of a blockchain that uses encrypted hashes.

FIG. 7 is a flow diagram of a process where a trusted authority is used to generate encrypted hash(es).

FIG. 8 is a flow diagram of a process where a trusted authority is used to validate a hash of a record.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

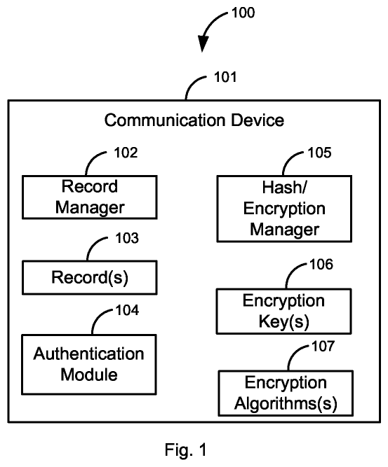

FIG. 1 is a block diagram of a first illustrative system 100 to provide an audit chain using encrypted hashes. The first illustrative system 100 comprises a communication device 101.

The communication device 101 can be or may include any device that produces record(s) 103 that need to be protected, such as a Personal Computer (PC), a telephone, a video system, a cellular telephone, a Personal Digital Assistant (PDA), a tablet device, a notebook device, a smartphone, an application server, a database server, a communications server, an email server, a social network, an embedded device, and/or the like. Although not shown in FIG. 1, the communication device 101 may be connected to a network.

The communication device 101 further comprises a record manager 102, record(s) 103, an authentication module 104, a hash/encryption manager 105, encryption key(s) 106, and encryption algorithm(s) 107. The record manager 102 manages the record(s) 103. For example, the record manager 102 may manage reads and writes of the record(s) 103. The record manager 102 may be a database system, an operating system, a hypervisor, and/or any type of system that manages the record(s) 103.

The record(s) 103 may be any type of record 103, such as, database records, blockchains, blockchain blocks, files, documents, medical records, employment records, computer records, user records, network management records, tracking records, corporate records, financial records, and/or the like. The record(s) 103 may comprise multiple types of records 103. For example, the record(s) 103 may comprise different types of database tables, different types of blockchain blocks, and/or the like. The record(s) 103 may be distributed across multiple communication devices 101.

The authentication module 104 can be any hardware coupled with software that provides access to the encryption key(s) 106/record(s) 103. The authentication module 104 may provide multi-factor/level authentication. For example, access to different encryption keys 106 may require a user to provide different and/or additional authentication factors in order to use the encryption key(s) 106 to unencrypt an encrypted hash. The authentication module 104 may use any type of authentication factor, such as, usernames/passwords, fingerprint scans, iris scans, faceprints, voiceprints, Short Message Service (SMS) codes, one-time passwords, questions, and/or the like. The authentication module 104 may provide multi-tenant access to individual record(s) 104.

The hash/encryption manager 105 can be or may include any hardware/software that can be used to manage the overall hashing/encryption processes to secure data stored in the record(s) 103. The hash/encryption manager 105 manages the encryption key(s) 106 and what encryption algorithm(s) 107 are used. The encryption keys 106 (e.g., encryption key sizes)/encryption algorithms 107 used may be defined based on rules. A user/administrator may administer the rules.

The encryption key(s) 106 are used to encrypt and unencrypt the hashes. There may be multiple encryption keys 106 that are used to provide different types of encrypted hashes. A first record 103 may use a different encryption key 106/encryption algorithm 107/hashing algorithm based on the first record 103 being a first type of record 103 (e.g., a government record). Likewise, a second record 103 may use a different encryption key 106/encryption algorithm 107/hashing algorithm based on the second record 103 being a second type of record 103 (e.g., a financial record). For example, the first record 103 may use a triple Data Encryption Standard (DES) encryption algorithm 107 and the second record 103 may use an Advanced Encryption Standard (AES) encryption algorithm 107. The encrypted hashes may use different hashing algorithms. For example, the first record 103 may use a Secure Hashing Algorithm (SHA) and the second record 103 may use a Rivest-Shamir-Adleman (RSA) hashing algorithm. In addition, the encryption key size may vary. For example, for one record 103, the encryption key size may be 256 bits and for another record 103 the encryption key size may be 128 bits. The encryption algorithm(s) 107 may be any encryption algorithm(s) 107, such as DES, AES, RSA, Blowfish, TwoFish, a Format Preserving Encryption (FPE) algorithm (e.g., Format-preserving Feistel-based Encryption Mode), and/or the like.

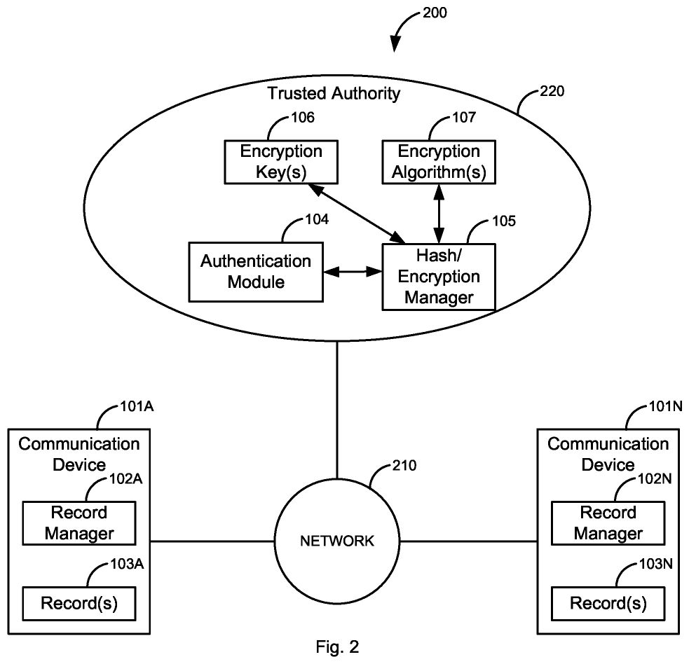

FIG. 2 is a block diagram of a second illustrative system 200 to provide an audit chain using encrypted hashes. The second illustrative system 200 comprises communication devices 101A-101N, a network 210, and a trusted authority 220.

The communication devices 101A-101N are similar to the communication device 101 described in FIG. 1. The communication devices 101A-101N comprise record managers 102A-102N and records 103A-103N. The record managers 102A-102N are similar to the record manager 102 described in FIG. 1. The records 103A-103N are similar to the record(s) 103 described in FIG. 1.

The network 210 can be or may include any collection of communication equipment that can send and receive electronic communications, such as the Internet, a Wide Area Network (WAN), a Local Area Network (LAN), a packet switched network, a circuit switched network, a cellular network, a combination of these, and/or the like. The network 110 can use a variety of electronic protocols, such as Ethernet, Internet Protocol (IP), Hyper Text Transfer Protocol (HTTP), Web Real-Time Protocol (Web RTC), and/or the like. Thus, the network 210 is an electronic communication network configured to carry messages via packets and/or circuit switched communications.

The trusted authority 220 is an auditing service that can be used to validate encrypted hashes of the record(s) 103. For example, the trusted authority 220 may be used to audit blocks in a blockchain or database records 103 using the encrypted hashes. In FIG. 2, the trusted authority 220 comprises the authentication module 104, the hash/encryption manager 105, the encryption key(s) 106, and the encryption algorithm(s) 107. In FIG. 2, the authentication module 104 and the hash/encryption manager 105 are provided as part of the trusted authority 220. In one embodiment, the authentication module 104 and/or hash/encryption manager 105 may be distributed between the trusted authority 220 and the communication devices 101A-101N.

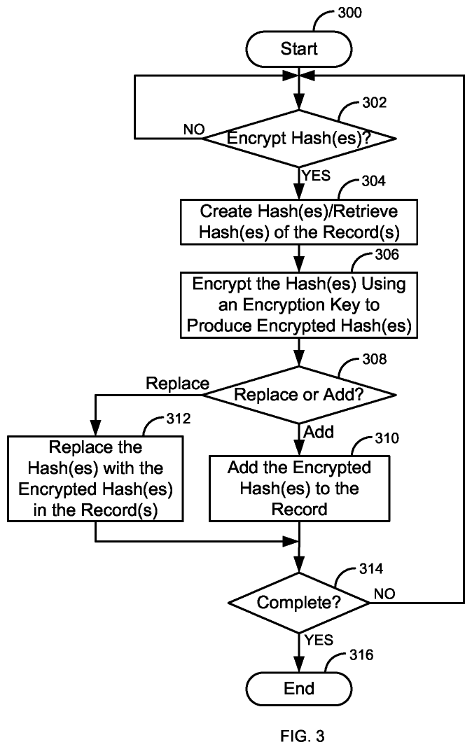

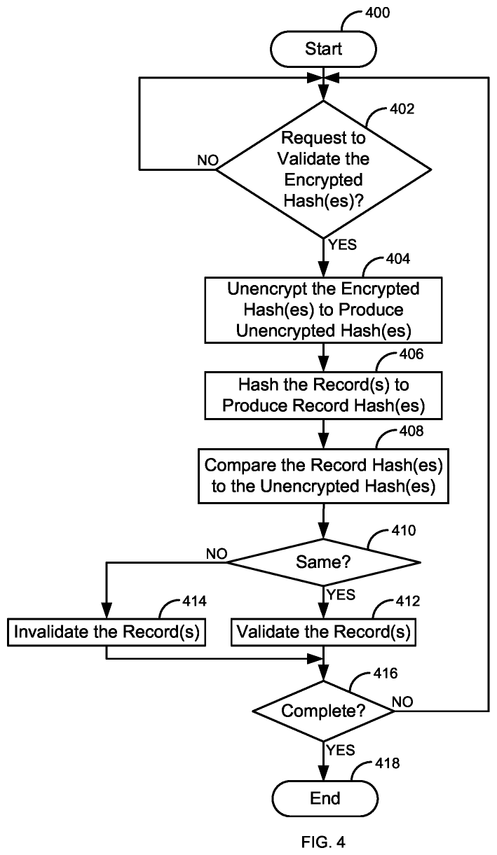

FIG. 3 is a flow diagram of a process for generating and storing encrypted hashes in a record 103. Illustratively, the communication device 101/101A-101N, the record manager 102/record managers 102A-102N, the record(s) 103/103A-103N, the authentication module 104, the hash/encryption manager 105, and the encryption algorithm(s) 107 are stored-program-controlled entities, such as a computer or microprocessor, which performs the method of FIGS. 3-4/7-8 and the processes described herein by executing program instructions stored in a computer readable storage medium, such as a memory (i.e., a computer memory, a hard disk, and/or the like). Although the methods described in FIGS. 3-4/7-8 are shown in a specific order, one of skill in the art would recognize that the steps in FIGS. 3-4/7-8 may be implemented in different orders and/or be implemented in a multi-threaded environment. Moreover, various steps may be omitted or added based on implementation.

The process starts in step 300. The hash/encryption manager 105 determines, in step 302, if there are any hashes to encrypt. What hashes to encrypt may be defined based on various rules. For example, the rules may determine that only specific record(s) 103 will have an encrypted hash while other records 103 will use non-encrypted hashes or have no hashes. The rules may be based on new and/or existing hashes in the record(s) 103. The rules may define specific types of records that will be encrypted using a specific encryption algorithm 107/encryption key size. If there are not any hashes to encrypt in step 302, the process of step 302 repeats.

If there are hashes to encrypt in step 302, the hash/encryption manager 105 creates/retrieves new hash(es) or retrieves existing hash(es) of the record(s) 103 in step 304. For example, the request may be to encrypt all existing hashes in an existing blockchain. The hash/encryption manager 105 encrypts the hash using the encryption key 106/encryption algorithm to produce an encrypted hash in step 306. For example, a Hash-Based Message Authentication Code (HMAC) process may be used. A key advantage of encrypting a hash is that it can potentially be used to also hide what hashing algorithm(s) are being used.

The hash/encryption manager 105 determines, in step 308, if the encrypted hash is going to replace an existing hash in the record 103 or if a new encrypted hash is to be added to the record 103. If an existing hash is going to be replaced with an encrypted hash in step 308, the hash is replaced with the encrypted hash in the record 103 in step 312 and the process goes to step 314. For example, the hashes of an existing blockchain may be replaced by the encrypted hashes.

In one embodiment, when the hash(es) are replaced with the encrypted hash(es), a different hashing algorithm may be used in order to hide the hashing algorithm. For example, the existing hash in the record 103 may be generated using a first hashing algorithm. When the encrypted hash is generated, a second hashing algorithm that is different from the first hashing algorithm is used to generate a second hash of the record. This second hash is encrypted using the encryption algorithm to produce the encrypted hash that it used to replace the existing hash in step 312.

Otherwise, if the encrypted hash(es) is a new encrypted hash(es) that are to be added to the record(s) 103 in step 308, the encrypted hash(es) are added to the record(s) 103 (e.g., the encrypted hash is added in part of a database table) in step 310 and the process goes to step 314. In one embodiment, the encrypted hash(es) may be stored outside the record(s) 103. For example, the encrypted hash may be stored in a separate record or file.

The hash/encryption manager 105 determines, in step 314, if the process is complete. If the process is not complete in step 314, the process goes back to step 302. Otherwise, if the process is complete in step 314, the process ends in step 316.

In one embodiment, some, or all of the data in the record(s) 103 may be encrypted. For example, the record 103 may be a user's medical record that is encrypted. In this example, the encrypted hash would cover the user's medical data before it was encrypted, or it also could cover it after it was encrypted. In this example, there may be two encryption keys 106 and/or encryption algorithms 107 used, one to encrypt the data and one to encrypt the hash of the unencrypted data.

FIG. 4 is a flow diagram of a process for unencrypting encrypted hashes to verify that a record 103 has not been tampered with. The process starts in step 400. The hash/encryption manager 105 determines, in step 402, if a request to validate the encrypted hash(es) has been received. If a request to validate the encrypted hash(es) has not been received in step 402, the process of step 402 repeats.

Otherwise, if a request to validate the encrypted hash(es) has been received in step 402, the hash/encryption manager 105 unencrypts the encrypted hash(es) to produce the unencrypted hash(es) in step 404. The hash/encryption manager 105 hashes the record(s) 103 associated with the encrypted hash(es) to produce record hash(es) in step 406. If the record(s) 103 are encrypted, the record(s) 103 may be unencrypted if the hash is of the unencrypted data in the record(s) 103. The hash/encryption manager 105 compares the record hash(es) to the unencrypted hash(es) in step 408. If the record hash(es) are the same as the unencrypted hash(es) in step 410, the record(s) 103 are validated in step 412 and the process goes to step 416. Otherwise, if the record hash(es) are not the same as the unencrypted hash(es) in step 410, the hash/encryption manager 105 invalidates the record(s) 103 in step 414. If the hash(es) don't match, this indicates that the record(s) 103 may have been tampered with.

The hash/encryption manager 105 determines, in step 416, if the process is complete. If the process is not complete in step 416, the process goes to step 402. Otherwise, if the process is complete in step 416, the process ends in step 418.

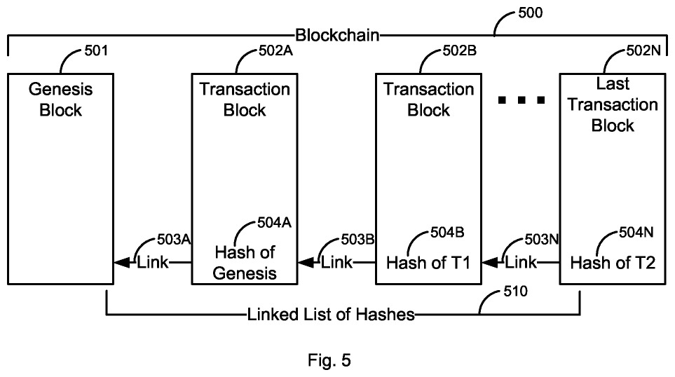

FIG. 5 is a block diagram of a blockchain 500 with hashes 504A-504N. The blockchain 500 is an example of a traditional blockchain 500. The blockchain 500 comprises a genesis block 501 and transaction blocks 502A-502N.

The genesis block 501 is the first block that is crated when the blockchain 500 is created. The transaction blocks 502A-502N are created based on transactions. A transaction is an event that is tracked in the blockchain 500. For example, an event may be an exchange of a cryptocurrency, a network event, an access to an account, a user login, a user logout, a change to a record 103, a change in privileges on an account, and/or the like. The transaction blocks 502A-502N may store different types of transactions/data. For example, the transaction block 502A may store data about a user access event and the transaction block 502B may store data about a change in account value of the user's bank account.

The blockchain 500 is linked together by links 503A-503N. The links 503A-503N are pointers to the previous block 501/502A/502B. The link 503A points to the genesis block 501. The link 503B points to the transaction block 502A. The link 503N points to the transaction block 502B. Each of the transaction blocks 502A-502B has a hash 504A-504N of the previous block. The hash 504A is a hash of the genesis block 501. The hash 504B is a hash of the transaction block 502A. The hash 504N is a hash of the transaction block 502B.

The hashes 504A-504N and the links 503A-503N form a linked list of hashes 510 that links each of the blocks 501/502A-502N in the blockchain 500 together. The linked list of hashes 510 is used to validate the integrity of each of the blocks 501/502A-502N in the blockchain 500. This is done by validating the hash 504 of the previous block 501/502 to make sure that the previous block 501/502 has not been changed. The linked list of hashes 510, coupled with the blockchain 500 being replicated in a distributed ledger are used to make the blockchain 500 highly immutable. Although the linked list of hashes 510 is described using forward links, the links 503 may be reverse links (i.e., links that point in the opposite direction) that have corresponding reverse hashes.

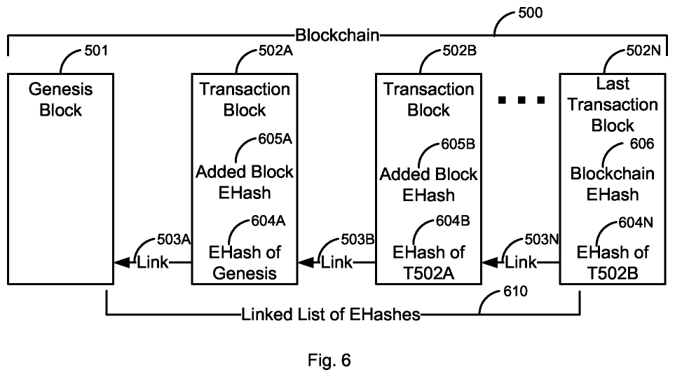

FIG. 6 is a block diagram of a blockchain 500 that uses encrypted hashes 604A-604N/605A-605B/606. The blockchain 500 comprises the genesis block 501 and the transaction blocks 502A-502N. Instead of the hashes 504A-504N, the blockchain 500 of FIG. 6 has encrypted hashes 604A-604N. The encrypted hashes 604A-604N along with the links 503A-503N form a linked list of encrypted hashes 610.

The encrypted hashes 604A-604N may be generated and added to the transaction blocks 502A-502N when each transaction block 502 is added to the blockchain 500. Alternatively, the encrypted hashes 604A-604N may be added after the transaction blocks 502A-502N are created by replacing the hashes 504A-504N with the encrypted hashes 604A-604N.

In addition, each of the transaction blocks 502A-502B has an added block encrypted hash 605A-605B. The added block encrypted hashes 605A-605B are encrypted hashes of the same block 502. For example, the added block encrypted hash 605A is an encrypted hash of the transaction block 502A. The added block encrypted hashes 605A-605B may use the same or a different hashing algorithms and/or encryption key sizes than the encrypted hashes 604A-604N. In addition, individual added block encrypted hashes 605A-605B may use different encryption algorithms 107 and/or encryption key sizes. For example, the added block encrypted hash 605A may use a different encryption algorithm 107 than the added block encrypted hash 605B. Thus a third party (e.g., the trusted authority 220) could provide an external validation of the blockchain 500 or an individual transaction block 502 in the blockchain 500. This could be on a single user/company basis or on a tenant basis. If the added block encrypted hash 605 uses a rotating (different) hashing algorithm on the blockchain 500 elements and then encrypts it, an attacker could not create a hash collision, and thus any hash collisions attacks can be detected.

The added block encrypted hashes 605A-605B may be generated and added to the transaction blocks 502A-502N when each transaction block 502 is added to the blockchain 500. Alternatively, the added block encrypted hashes 605A-605B may be retroactively added after the transaction blocks 502A-502B are created. Although not shown, the transaction block 502N may also have an added block encrypted hash (e.g., added block encryption hash 605N).

By adding the encrypted hashes 604A-604N/added block encrypted hashes 605A-605B/blockchain encrypted hashes 606, this allows the trusted authority 220 (e.g., a notary) to then unencrypt the encrypted hashes 604A-604N/added block encrypted hashes 605A-605B/blockchain encrypted hashes 606 and either validate or enable the validation of the encrypted hashes 604A-604N/605A-605B. Because only the trusted authority 220 knows the encryption key(s) 106 for the encrypted hashes 604/605, a malicious party will be unable to identify any hash collisions. If there are two encrypted hashes (e.g., encrypted hashes 604B/605A), there will not be any hash collisions that are not detected.

The last transaction block 502N of a completed blockchain 500 may also have an encrypted blockchain hash 606 that is a full hash of the blockchain 500. This can be used to validate the completed blockchain 500. The hashing algorithms used for individual transaction blocks 502/last transaction block 502N may use a different and/or the same hashing algorithm of the blockchain 500.

While described using blockchains 500, this technique can be used in various other environments, such as file verification, record 103 verification, and/or the like. For example, the encrypted hash(es) 605 could be used in a document/file where the encrypted hash 604/605 is encrypted and only a trusted authority 220 can be used to validate the document/file. Since a person does not know the encryption key 106, they cannot determine how to change the document/file to create a hash collision. In this embodiment, there could be two encryption keys 106 to unlock/validate a file, one to unencrypt the data in the file and one to unencrypt the encrypted hash 604/605 to verify the encrypted or unencrypted data. The hash may be over the unencrypted data in the file or over the encrypted data in the file.

In one embodiment, a HMAC may be used for a low value transaction/document (or for any of the embodiments described herein). For a higher value/different type of transaction block 502/document may use different type of encryption (e.g., Private Key Exchange (PKI)). The encryption may be based on the transaction type, block type, file type, owner, etc. In addition, a different encryption type/strength/HMAC may be used based on this information.

There may be multiple authentication levels to validate different transaction blocks 502/records 103 by the authentication manager 104. For example level one authentication may get an encryption key 106 to validate a specific type of transaction block 502. Level two authentication can be used to validate a second kind of transaction block 502. Multiple authentication levels may be associated with higher/different encryption. The encryption keys 106 may be assigned on a tenant basis. For example, the trusted authority 220 may have different encryption keys 106 for different tenants. The different encryption keys 106 may also have an associated authentication level/tenant. For example, tenant A may have two encryption keys 106 that require two different authentication levels and tenant B may have three encryption keys 106 that require three different authentication levels.

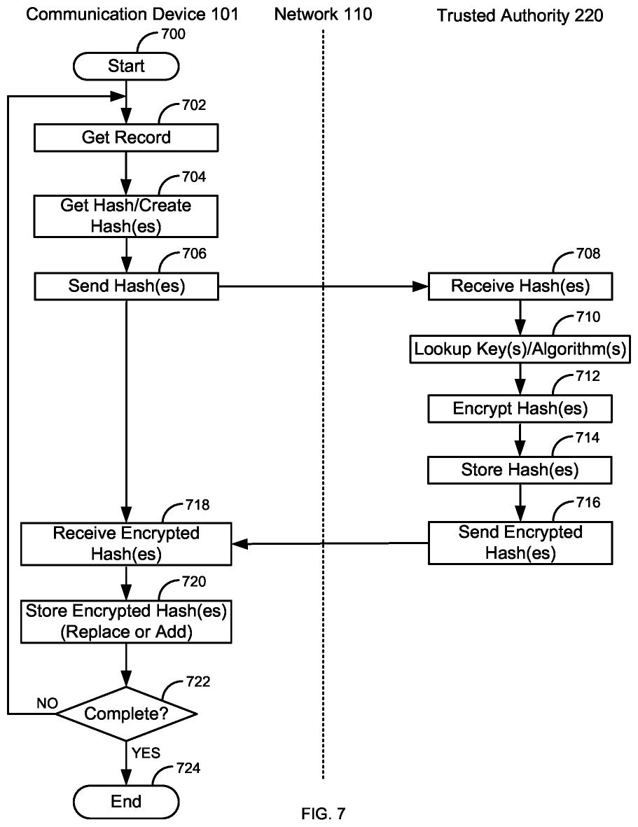

FIG. 7 is a flow diagram of a process where a trusted authority 220 is used to generate encrypted hash(es). The process starts in step 700 on the communication device 101. The communication device 101 gets the record(s) 102 in step 702. The communication device 101 gets the hashes and/or creates the hashes for the record(s) 102 in step 704. The communication device 101 sends the hash(es) to the trusted authority 220 in step 706. The message of step 706 may include other information, such as, record identifier(s), hash identifier(s) (e.g., the record 102 has multiple hashes), encryption key size information, encryption algorithms 107 to be used, and/or the like.

The trusted authority 220 receives the hash(es) in step 708. The trusted authority 220 looks up the encryption key(s) 106/encryption algorithms 107 that are associated with the record(s) 102 in step 710. For example, the trusted authority 220 may use defined encryption key size(s)/encryption algorithm(s) 107/hashing algorithm(s) based on an agreement/contract. The defined encryption key size(s)/encryption algorithm(s) 107/hashing algorithm(s) may be different depending on a type of the record 102.

The trusted authority 220 encrypts the hash(es) in step 712. In one embedment, the trusted authority 220 may hash the received hash(es) using a different hashing algorithm before encrypting the hashes in step 712. This may be used to obfuscate the encryption algorithm 107 used by the trusted authority 220. The trusted authority 220 stores the hash(es) in step 714. The storing of the hash(es) may include the received hashes of step 708 and/or the encrypted hashes of step 712. In addition, other information may be stored in step 714, such as, record identifier(s), a hash identifier(s), encryption key size information, encryption algorithm(s) 107 used, and/or the like. The trusted authority 220 sends the encrypted hash(es) to the communication device 101 in step 716.

The communication device 101 receives the encrypted hash(es) in step 718. The communication device 101 stores, in step 720, the encrypted hashes by adding and/or replacing the existing hash(es) in the record 102. The communication device 101 determines, in step 722, if the process is complete. If the process is not complete, in step 722, the process goes back to step 702. Otherwise, if the process is complete in step 722, the process ends in step 724.

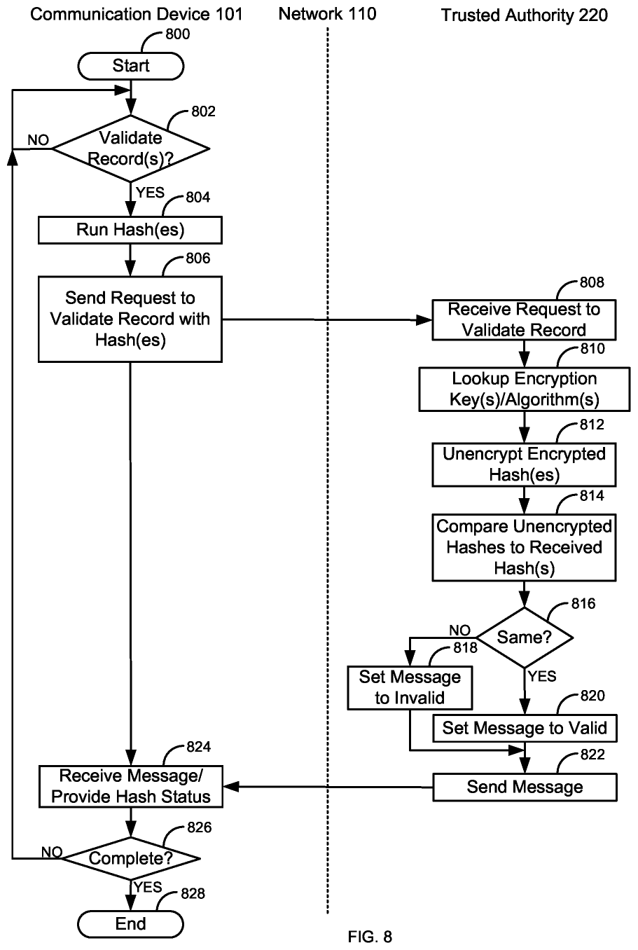

FIG. 8 is a flow diagram of a process where a trusted authority 220 is used to validate a hash of a record 102. The process starts on the communication device 101 in step 800. The communication device 101 determines, in step 802, if the record(s) 102 need to be validated. If the record(s) 102 are not to be validated in step 802, the process of step 802 repeats.

Otherwise, if the record(s) 102 are to be validated in step 802, the communication device 101 runs hash(es) over the record(s) 102/data in the record(s) 102 that are to be validated in step 804. The communication device 101 sends a request to validate the record(s) 102 to the trusted authority 220 in step 806. The request of step 806 includes the hash(es) generated in step 804. In addition, the request of step 806 may include record identifier(s), hash identifier(s), and/or the like.

The trusted authority 220 receives the request to validate the record in step 808. The trusted authority 220 looks up the associated encryption key(s) 106/encryption algorithm(s) 107 in step 810. The trusted authority 220 unencrypts the encrypted hash(es) in step 812. For example, an encrypted hash may have an associated record ID/hash ID that indicates the encryption key 106/encryption algorithm 107 used to encrypt the encrypted hash.

The trusted authority 220 compares, in step 814, the unencrypted hash(es) of step 812 to the received hash(es) of step 808. If the hash(es) are the same in step 816, the message is set to indicate the hash(es) are valid in step 820. Otherwise, if the hash(es) are not the same in instep 816, the message is set to invalid in step 818. If some of the hash(es) are valid and some of the hash(es) are invalid, the message will indicate which of the hash(es) are valid and which of the hash(es) are invalid. The message is then sent by the trusted authority in step 822 to the communication device 101.

While not shown in FIG. 8, instead of unencrypting the hash(es) in step 812 to make the comparison in step 814, the trusted authority 220 may just use the received hash(es) of step 708 and compare them to the received hash(es) of step 808. Another option would be to generate encrypted hash(es) from the hash(es) received in step 808 and compare it to the stored encrypted hashes (stored in step 714) to see if they are the same.

The communication device 101 receives the message in step 824. The communication device 101 provides the hash status in step 824. For example, an administrator may be notified that a record 102 may have been compromised or corrupted. Although not shown, step 824 may include an action, such as, locking the record 102, denying access to the record 102, restoring the record 102 from a backup system, and/or the like. The action may be automated and/or based on user input.

The communication device 101 determines, in step 826, if the process is complete. If the process is not complete in step 826, the process goes back to step 802. Otherwise, the process ends in step 828.

All the processes described herein may be used based on the systems described in FIGS. 1-2. In addition, embodiments that are a combination of FIGS. 1-2 may be implemented. For example, the authentication module 104, the hash/encryption manager 105, the encryption key(s) 106, and/or the encryption algorithms 107 may reside on the communication device 101, in the trusted authority, in a combination of the two, or may be distributed between the communication devices 101A-101N and the trusted authority 220.

In one embodiment, the trusted authority manages encryption of the hash(es) 220. The customer registers with trusted authority 220 (a Notary). Because the trusted authority 220 either accepts a key from customer or generates a key for them (associated with the customer), the trusted authority 220 assigns a communication key, which it also associates with the customer. The trusted authority 220 notarizes the request. The request is sent to the trusted authority 220. The trusted authority 220 looks up customer code and retrieves a registered key. The trusted authority 220 encrypts the hash(es) with the customer key. The trusted authority sends back encrypted hash(es) (sealed with communication customer key). Customer requests a validate and sends the encrypted hash(es). The trusted authority looks up customer, decrypts hash(es), and sends hash(es) back to customer (could be sealed with customer communication key). The customer compares hashes and validates that the hashes match.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD. PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that, when executed by the microprocessor, cause the microprocessor to:
retrieve a first hash of a record;
encrypt the first hash of the record using a first encryption key to produce an encrypted hash, wherein the encrypted hash is stored in the record and wherein storing the encrypted hash in the record comprises one of: replacing the first hash with the encrypted hash or adding the encrypted hash to the record;
receive a request to validate the record;
in response to receiving the request to validate the record, validate the record by:
unencrypting the encrypted hash using the first encryption key to produce a second hash;
hashing the record to produce a third hash; and
comparing the second hash to the third hash;
in response to the second hash being the same as the third hash, validating the record; and
in response to the second hash not being the same as the third hash, not validating the record.

2. The system of claim 1, wherein storing the encrypted hash in the record comprises adding the encrypted hash to the record.

3. The system of claim 3, wherein the record is a newly added block in a blockchain and wherein the first hash is hash of a previous block in the blockchain.

4. The system of claim 3, wherein the record is a transaction block in a blockchain and wherein the encrypted hash is a hash of the blockchain and/or a hash of the transaction block.

5. The system of claim 3, wherein the record is a block in a blockchain and wherein the encrypted hash uses a hashing algorithm that is different from another hash in the block in the blockchain.

6. The system of claim 1, wherein storing the encrypted hash in the record comprises replacing the first hash with the encrypted hash.

7. The system of claim 6, wherein the first hash is a hash of a previous block in a blockchain.

8. The system of claim 1, wherein the first hash comprises a plurality of hashes of previous blocks in a blockchain and wherein each of the plurality of previous hashes of the previous blocks are encrypted using the first encryption key to produce a linked list of encrypted hashes in the blockchain.

9. The system of claim 1, wherein at least a portion of the record is encrypted using a second encryption key and/or encryption algorithm and wherein the encrypted hash is of the at least a portion of the record before the at least a portion of the record was encrypted.

10. The system of claim 1, wherein the record is a blockchain that comprises a plurality of different types of blocks and wherein the encrypted hash comprises a plurality of encrypted hashes of the plurality of different types of blocks that are encrypted using different encryption algorithms and/or encryption keys.

11. The system of claim 1, wherein the encrypted hash has an associated authentication level in order to unencrypt the encrypted hash.

12. The system of claim 1, wherein the encrypted hash comprises a plurality of encrypted hashes associated with a plurality of tenants, wherein the first encryption key comprises a plurality of encryption keys associated with the plurality of tenants, and wherein each of the plurality of encrypted hashes has an associated authentication level to access one or more of the plurality of encryption keys for each of the plurality of tenants.

13. The system of claim 1, wherein the first hash uses a first hashing algorithm, wherein the encrypted hash replaces a fourth hash that is stored in the record and wherein the fourth hash uses a second hashing algorithm.

14. A method comprising:
retrieving, by a microprocessor, a first hash of a record;
encrypting, by the microprocessor, the first hash of the record using a first encryption key to produce an encrypted hash, wherein the encrypted hash is stored in the record and wherein storing the encrypted hash in the record comprises one of: replacing the first hash with the encrypted hash or adding the encrypted hash to the record;
receiving, by the microprocessor, a request to validate the record;
in response to receiving the request to validate the record, validating, by the microprocessor, the record by:
unencrypting the encrypted hash using the first encryption key to produce a second hash;
hashing the record to produce a third hash; and
comparing the second hash to the third hash;
in response to the second hash being the same as the third hash, validating, by the microprocessor, the record; and
in response to the second hash not being the same as the third hash, not validating, by the microprocessor, the record.

15. The method of claim 14, wherein storing the encrypted hash in the record comprises adding the encrypted hash to the record.

16. The method of claim 15, wherein the record is a newly added block in a blockchain and wherein the first hash is hash of a previous block in the blockchain.

17. The method of claim 14, wherein storing the encrypted hash in the record comprises replacing the first hash with the encrypted hash.

18. The method of claim 14, wherein the first hash comprises a plurality of hashes of previous blocks in a blockchain and wherein each of the plurality of previous hashes of the previous blocks are encrypted using the first encryption key to produce a linked list of encrypted hashes in the blockchain.

19. A system comprising:
a microprocessor; and
a computer readable medium, coupled with the microprocessor and comprising microprocessor readable and executable instructions that, when executed by the microprocessor, cause the microprocessor to:
receive a first hash of a record from a communication device;
encrypt the first hash of the record using a first encryption key to produce an encrypted hash, wherein the encrypted hash is stored in the record and wherein storing the encrypted hash in the record comprises one of: replacing the first hash with the encrypted hash or adding the encrypted hash to the record;
send the encrypted hash of the record to the communication device;
receive a request to validate the record from the communication device, wherein the request to validate the record comprises a second hash of the record;
in response to receiving the request to validate the record from the communication device, validate the record by at least one of:
unencrypting the encrypted hash using the first encryption key to produce a third hash and comparing the third hash to the second hash;
retrieving the first hash and comparing the first hash to the second hash; and/or
retrieving the encrypted hash and comparing the encrypted hash to an encrypted hash generated from the second hash;
in response to any of the comparisons being the same, send a message to validate the record to the communication device; and
in response to any of the comparisons not being the same, send a message to invalidate the record to the communication device.

20. The system of claim 19, wherein the received first hash is hashed using a different hashing algorithm before being encrypted using the first encryption key.
